(19) United States
(12) Patent Application Publication
(10) Pub. No.: US 2015/0240973 A1
(43) Pub. Date: Aug. 27, 2015

(54) SPIGOT COUPLINGS

(71) Applicant: BROWN & MILLER RACING SOLUTIONS LIMITED, Slough (GB)

(72) Inventor: Barry Charles MILLER, Surrey (GB)

(21) Appl. No.: 14/628,574

(22) Filed: Feb. 23, 2015

(30) Foreign Application Priority Data
Feb. 25, 2014 (GB) 1403280.9

(51) Int. Cl. F16L 15/04; F16L 19/02; F16L 15/08

(52) U.S. Cl. CPC F16L 15/04; F16L 15/08; F16L 19/0237

(57) ABSTRACT

A spigot coupling (5; 20; 30; 40) to an externally-threaded tubular end-fitting (7; 21) of a hose (6), is formed with a circumferential bead (3; 23) at an intermediate location of the length of the spigot (2; 24) entered into the end-fitting through an internally-threaded nut (12) and an elastomeric ring (13). Internal threads (16) of the nut are engaged with the externally-threaded head (8; 29) of the end-fitting to screw the nut onto the end-fitting with the elastomeric ring squeezed circumferentially between the head and an inclined face (15) of an internal shoulder of the nut. This secures the spigot to the end-fitting and establishes a fluid connection with the hose. Where the spigot (24) is of extended length it may project further into the end-fitting (21) through a further elastomeric ring (25) trapped inside the end-fitting. The spigot (31; 41) may have a frusto-conical distal-end (32; 42) with a shoulder (33; 47) instead of the bead for providing the squeezing action onto the inclined face (39; 44). The end-fitting of one coupling (40) may be an adaptor (46) that enables a screw-threaded connection to the spigot.

This application claims priority from British patent application serial no. 1403280.9 filed Feb. 25, 2014.

### FIELD OF THE INVENTION

This invention relates to couplings of a kind for securing a tubular member to a cylindrical spigot.

### BACKGROUND OF THE INVENTION

It is common in the automotive industry for flexible hose couplings to components such as oil and other filters, fuel pumps and rails, water pumps and radiators, to be formed by pushing the hose onto a tubular spigot of the component and securing it there with a spring clip or other retainer that encircles the hose to grip it resiliently onto the external surface of the spigot. Retention of the hose may be enhanced by locating the clip or other retainer beyond where there is a localised increase in external diameter of the spigot in the form of a circumferential bead or shoulder.

However, the use in motorsport of the readily-available automotive components is in general limited because of the need to provide a more-secure coupling of the hose to the spigot than can be provided using an encircling spring clip or other retainer, even where the spigot has a circumferential bead or shoulder. The need is also for a coupling that will enable the hose to be more-easily connected and disconnected from the spigot.

### SUMMARY OF THE INVENTION

It is an object of the present invention to provide a spigot coupling that meets these needs.

According to one aspect of the present invention there is provided a coupling of an externally-threaded tubular member to a cylindrical spigot, wherein the spigot projects through an internally-threaded nut member and an elastomeric ring into the tabular member with a localised circumferential portion of increased external diameter of the spigot located within the tubular member, and the internal threads of the nut member are engaged with the external threads of the tubular member to screw the two members together with the elastomeric ring squeezed circumferentially between an internal shoulder of the nut member and the increased-diameter portion of the spigot to secure the tubular member to the spigot.

The spigot coupling of the invention provides a secure mechanical connection between the tubular member and the spigot, and where the spigot is in the form of a tube, the coupling may be used for establishing a fluid connection between them. More especially, the spigot coupling of the present invention enables a hose attached to the tubular member to be easily and rapidly connected securely to the spigot simply by screwing the nut and tubular members together, and also to be easily and rapidly disconnected positively from the spigot by unscrewing them from one another.

The increased-diameter portion of the spigot may be a circumferential bead or annular shoulder, and the internal shoulder of the nut member may have an annular face which is inclined to the axis of the nut member, it being between this face and the increased-diameter portion of the spigot that the elastomeric ring is squeezed. The nut member may have sin internal diameter that throughout the inclined annular face axially of the nut member increases from the diameter of a top-end opening of the nut member to the diameter of the internal threads of the nut member.

### BRIEF DESCRIPTION OF THE DRAWINGS

Examples of spigot couplings in accordance with the present invention will now be described with reference to the accompanying drawings, in which:

FIG. 1 is illustrative or an automotive component having tubular spigot ends for input and output of fluid;

FIG. 2 is illustrative of the automotive component of FIG. 1 fitted with spigot couplings according to the invention for attaching hose connections to its input and output spigots;

FIGS. 3 and 4 are, respectively, exploded perspective and longitudinal sectional views of one of the spigot couplings of FIG. 2 (for clarity, the spigot of the coupling in these, and subsequent figures the drawings, is shown detached from any component of which it forms part);

FIGS. 5 and 6 are, respectively, a side elevation and a sectional side-elevation of the assembled spigot coupling of FIGS. 3 and 4, FIG. 6 being to an enlarged scale with the section taken on the line VI-VI of FIG. 5;

FIGS. 7 and 8 are, respectively, exploded perspective and longitudinal sectional views of a modified form of spigot coupling of FIGS. 3 to 6;

FIGS. 9 and 10 are, respectively, a side elevation and a sectional side-elevation of the assembled modified form of spigot coupling of FIGS. 7 and 8, FIG. 10 being to an enlarged scale with the section taken on line X-X of FIG. 9;

FIGS. 11 and 12 are, respectively, an exploded perspective view and a sectional side-elevation of a third form of spigot coupling in accordance with the present invention; and

FIGS. 13 and 14 are, respectively, an exploded perspective view and a sectional side-elevation of a fourth form of spigot coupling in accordance with the present invention.

### DETAILED DESCRIPTION OF THE PREFERRED EMBODIMENTS

Referring to FIG. 1, the illustrated automotive component 1 (which, for example, may be an oil filter) has tubular spigots 2 for fluid input and output. Each spigot 2 has a localised circumferential portion of its length that is of increased external diameter forming a circumferential bead 3 near its distal end 4.

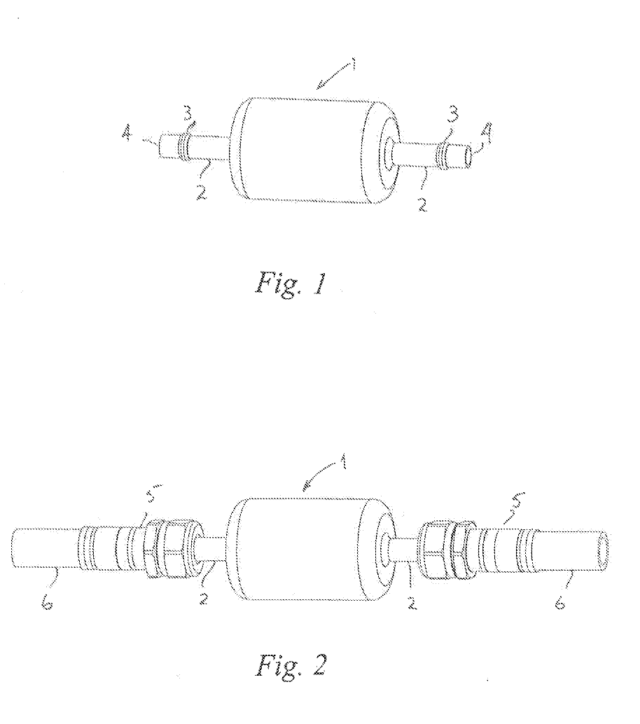

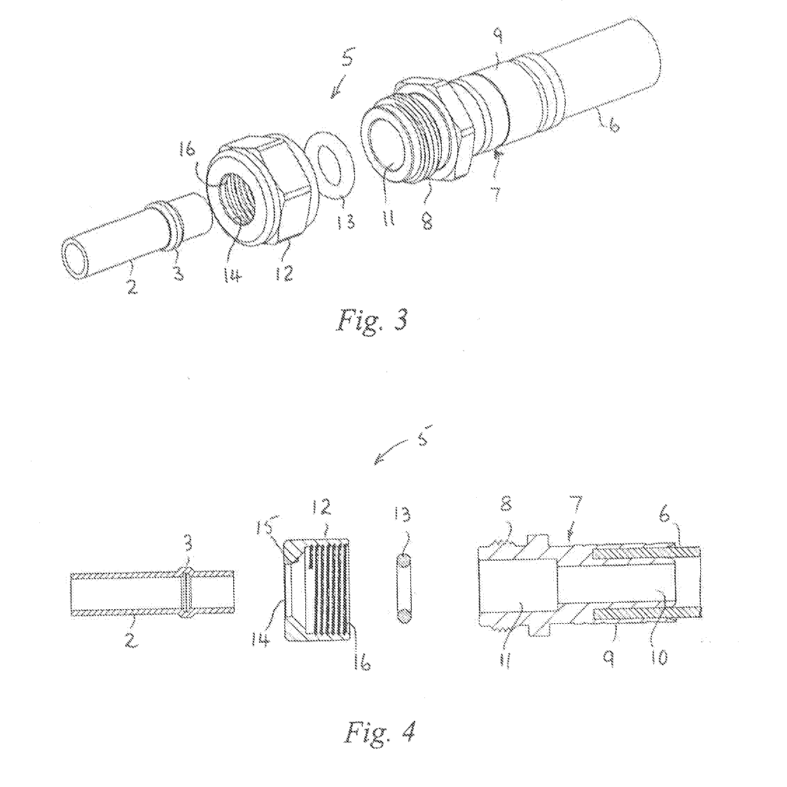

As illustrated in FIG. 2, connections to the two spigots 2 of the component 1 are made by means of respective, identical couplings 5 each according to the present invention. Each coupling 5 is constructed and functions as will now be described with reference to FIGS. 3 to 6, to establish a secure fluid interconnection between a hose 6 and the spigot 2.

Referring initially to FIGS. 3 and 4, each coupling 5 involves a tubular end-fitting 7 that has an externally-threaded head 8 and a tubular rear-extension 9. The rear-extension 9 projects into the hose 6 and it is to the extension 9 that the hose 6 is secured in its attachment to the coupling 5. The bore 10 of the rear-extension 9 is enlarged within the head 8 into a chamber 11 that has a diameter sufficient to accommodate the bead 3 of the spigot 2 in the assembled coupling 5.

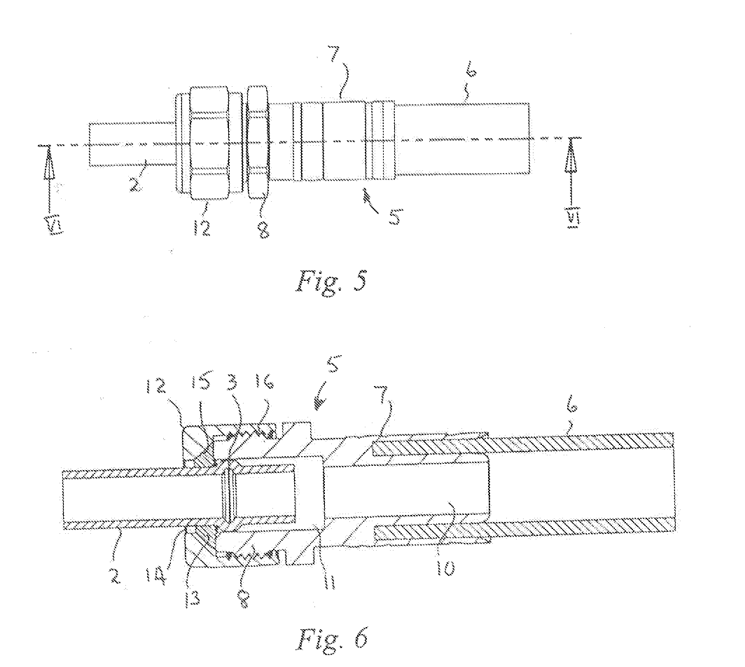

In the latter regard, and referring now also to FIGS. 5 and 6, the coupling 5 is assembled by first threading a nut 12 and an elastomeric O-ring 13 onto the spigot 2, in that order with a top-end opening 14 of the nut 12 leading, the nut 12 has an internal profile that from the top-end opening 14 extends coaxially via an annular inclined face 15 of an internal shoulder to internal threads 16 of larger diameter suitable for engagement with the externally-threaded head 8. The top-end opening 14 of the nut 12 is of slightly larger diameter than the bead 3, whereas the natural, undistorted external and internal diameters of the O-ring 13 are respectively larger and only-slightly smaller than that of the bead 3. The nut 12 accordingly passes down the spigot 2 beyond the bead 3, but the O-ring 13 needs to be urged under its resilience over the bead 3 in order to locate it inside the nut 12 against the annular inclined face 15.

In further assembly of the coupling 5, the fitting 7 is brought onto the spigot 2 with the spigot 2 projecting through the O-ring 13 into the chamber 11. The nut 12 is now closed onto the fitting 7 to engage its threads 16 with the externally-threaded head 8 and sandwich the O-ring 13 circumferentially between the annular inclined-face 15 and the bead 3. Tightening of the nut 12 on the head 8 squeezes the O-ring 13 to secure the fitting 7 to the spigot 2 with the bead 3 located in the chamber 11, as illustrated in FIG. 6. The axial strength provided by this compression of the O-ring 13 onto the face 15 of the nut 12 retains the fitting 7 securely to the spigot 2 with effective sealing under fluid pressure. The coupling is easily connected simply by screwing the nut 12 and fitting 7 together, and is also easily and rapidly disconnected from the spigot 2 by unscrewing them from one another.

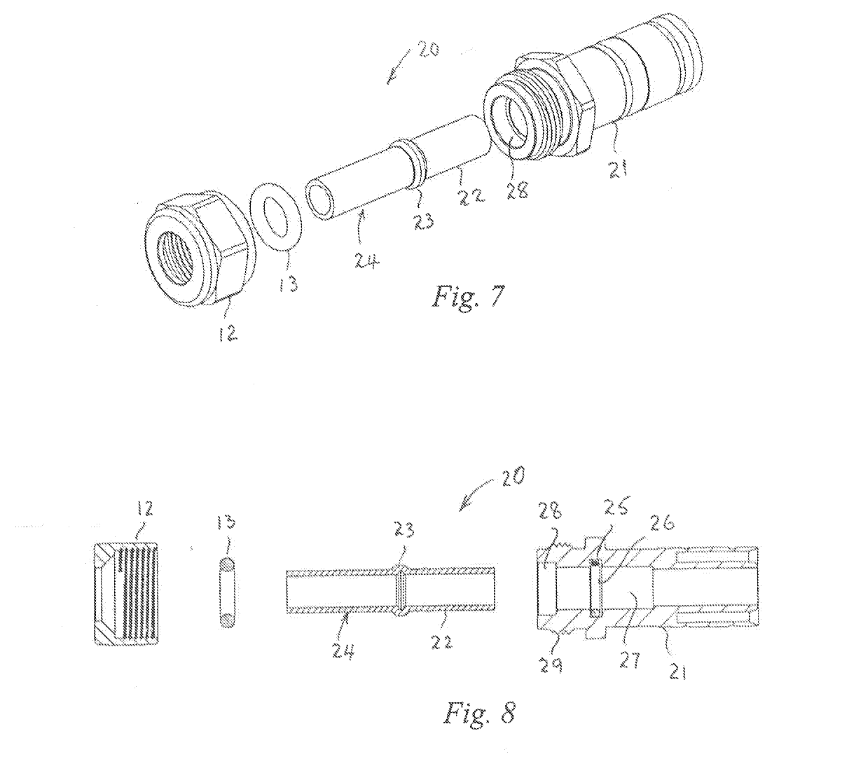

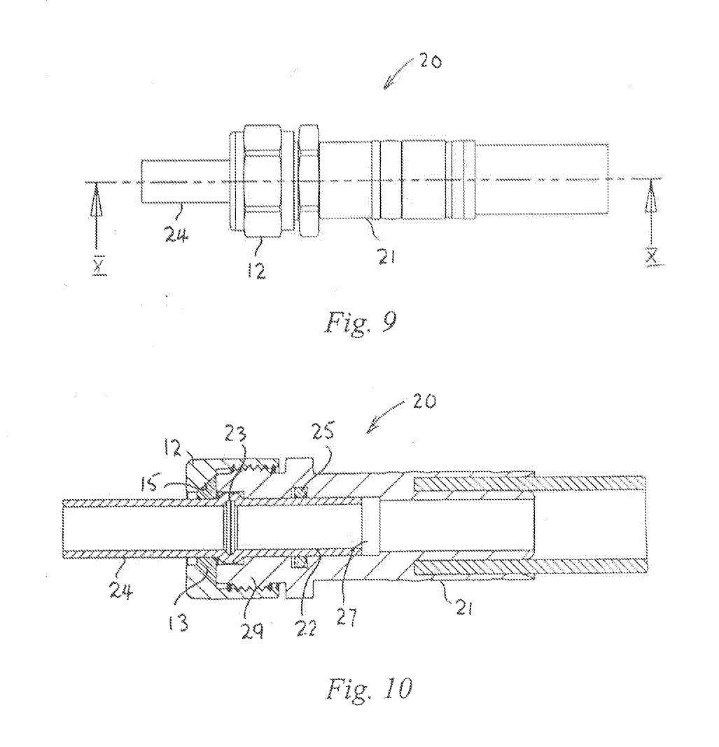

In the circumstances in which there is an extended length of the spigot from its distal end to the bead or other shoulder, added sealing may be incorporated into the coupling to the spigot. A coupling modified in this respect is illustrated in FIGS. 7 to 10, and will now be described.

Referring to FIGS. 7 to 10, the modified coupling 20 differs from the coupling 5 of FIGS. 3 to 6 solely in that the tubular fitting 7 of the latter coupling is replaced by a modified tubular fitting 21 for receiving the extended leading end 22 to the bead 23 of the spigot 24. Components of the modified coupling 20 that are unchanged from those of the coupling 5 described with reference to FIGS. 3 to 6 retain the same references in FIGS. 7 to 10 as in FIGS. 3 to 6.

The modified fitting 20 includes an additional elastomeric O-ring 25 that is trapped resiliently in an internal annular groove 26 of the bore 27 of the fitting 21. In assembly of the modified coupling 20, the fitting 21 is brought onto the spigot 24 to enter the leading end 22 of the spigot 24 into the bore 27 after the nut 12 and the O-ring 13 have been threaded over the bead 23. The fitting 21 is now pushed further onto the spigot 24 to enter the leading end 22 of the spigot 24 through the O-ring 25 and the bead 23 into a chamber 28 of the externally-threaded head 29 of the fitting 21. Tightening of the nut 12 onto the head 29 with the O-ring 13 under the nut 12 establishes a secure coupling with the added sealing provided by the O-ring 25.

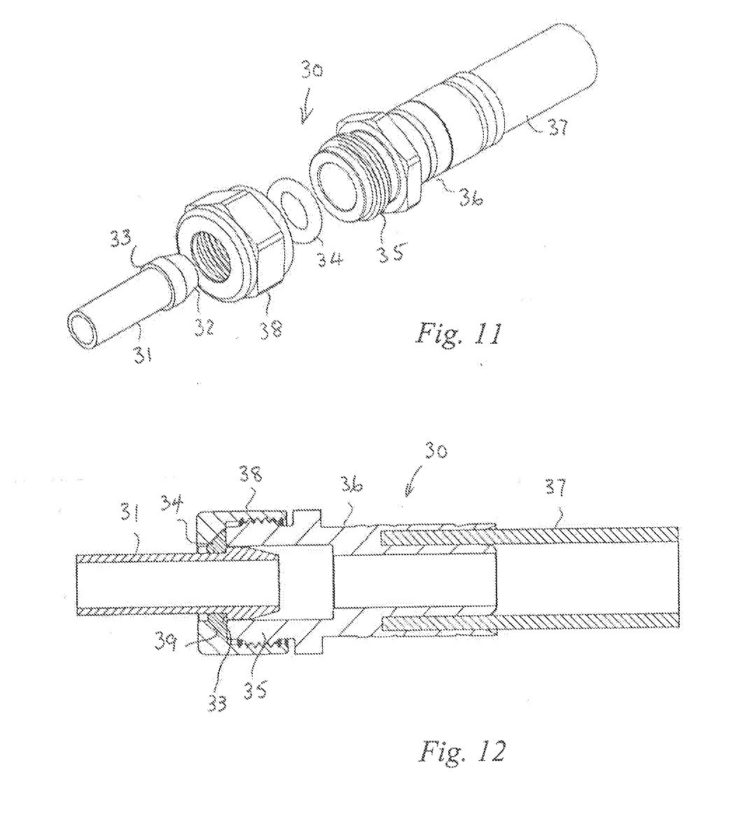

Although in the two examples of spigot couplings described above with reference to FIGS. 3 to 10, the localised circumferential portion of increased external diameter of the spigot in each case has the form of a circumferential bead, the coupling according to the present invention is not limited in its application to spigots of this form. In this respect, a spigot coupling according to the present invention in which the spigot features a different form of the localised circumferential portion of increased external diameter, is illustrated in FIGS. 11 and 12 and will now be described.

Referring to FIGS. 11 and 12, the coupling 30 in this case is with a spigot 31 that has a machined distal-end 32 of frusto-conical form that includes a circumferential shoulder 33. In the assembled coupling 30, the frusto-conical end 32 projects through an elastomeric O-ring 34 into the externally-threaded head 35 of a tubular fitting 36 to which a hose 37 is attached, and it is the shoulder 33 that bears on the O-ring 34 within a nut 38 screwed onto the head 35. Tightening of the nut 38 squeezes the O-ring 34 against an internal inclined annular face 39 of the nut 38 to establish a secure and sealed coupling of the fitting 36, and with it the hose 37, to the spigot 31.

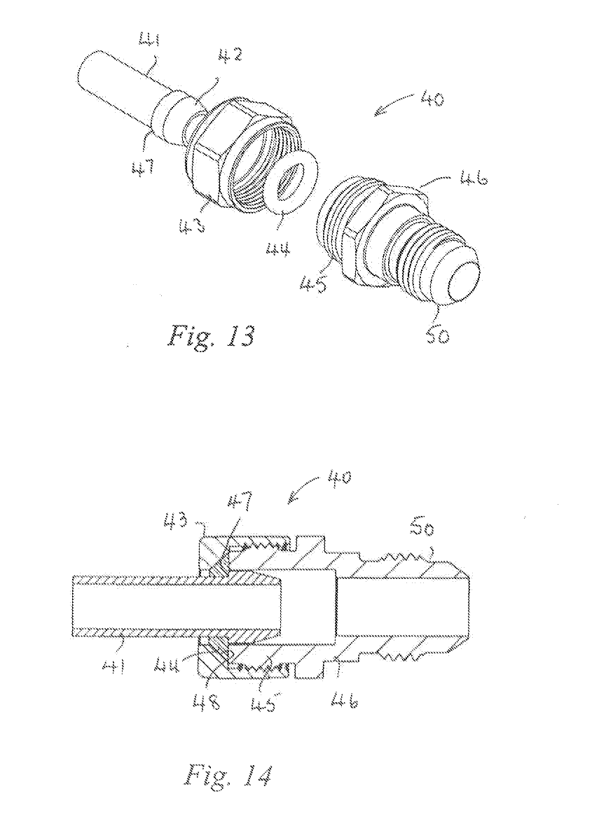

It is not necessary that the spigot-coupling of the present invention establishes a hose connection to the spigot. For example, the spigot coupling illustrated in FIGS. 13 and 14, provides a secure connection between a spigot and an externally-threaded adaptor which may be used selectively as a connection point for a hose or other item.

Referring to FIGS. 13 and 14, the coupling 40 in this example, like the coupling 30, involves a spigot 41 that has a machined distal end 42 of frusto-conical form. In the assembled coupling, the machined end 42 of the spigot 41 projects through a nut 43 and an elastomeric O-ring 44 into the externally-threaded head 45 of the tubular adaptor 46. A shoulder 47 of the end 42 of the spigot 41 bears on the O-ring 44 within the nut 43 screwed onto the head 45. Tightening of the nut 43 squeezes the O-ring 44 against an inclined internal annular face 48 of the nut 43, to establish the mechanically-secure connection of the adaptor 46 to the spigot 41. An externally-threaded nose 50 of the adaptor 46 enables screw-threaded connection to be made readily and securely via the adaptor 46 to the spigot 41, and furthermore readily enables disconnection to be made.

Although the coupling 40 facilitates fluid connection between the adaptor 46 and the spigot 41, the coupling 40 is capable of use solely for the purpose of establishing a mechanical coupling between the two.

1. A spigot coupling tor coupling an externally-threaded tabular member to a cylindrical spigot, wherein:
the cylindrical spigot has a localised circumferential portion of increased diameter,
the cylindrical spigot projects through a nut member and an elastomeric ring into the tubular member with the localised circumferential portion of the cylindrical spigot located within the tubular member,
the nut member has internal screw threads and an internal shoulder for abutment by the elastomeric ring, and
the internal screw threads of the nut member are engaged with external screw threads of the tubular member screwing together the nut member and the tubular member with the elastomeric ring squeezed circumferentially between the internal shoulder of the nut member and the increased-diameter portion of the spigot to secure the tubular member to the spigot.

2. The spigot coupling according to claim 1, wherein the cylindrical spigot is tubular to establish a fluid connection between the cylindrical spigot and the tubular member.

3. The spigot coupling according to claim 2 wherein a hose is attached to the tubular member for fluid connection to the cylindrical spigot via the tubular member.

4. The spigot coupling according to claim 1 wherein the localised circumferential portion of increased diameter of the cylindrical spigot is a circumferential bead.

5. The spigot coupling according to claim 1 wherein the localised circumferential portion of increased diameter of the cylindrical spigot is an annular shoulder.

6. The spigot coupling according to claim 1, wherein the localised circumferential portion of increased diameter of the cylindrical spigot is an annular shoulder at a distal-end of the cylindrical spigot.

7. The spigot coupling according to claim 6, wherein the distal-end of the cylindrical spigot is of frusto-conical form including a shoulder for bearing on the elastomeric ring in squeezing the ring circumferentially onto the internal shoulder of the nut member

8. The spigot coupling according to claim 1 wherein the internal shoulder of the nut member has an annular inclined-face for abutment by the elastomeric ring.

9. The spigot coupling according to claim 1, wherein the cylindrical spigot projects further into the tubular member through a further elastomeric ring trapped within the tubular member.

10. The spigot coupling according to claim 1 wherein the externally-threaded tubular member is a tubular adaptor having a threaded nose enabling secure screw-threaded connection to be made to the cylindrical spigot via the tubular adaptor.
